(19) United States
(12) Patent Application Publication
(10) Pub. No.: US 2026/0236958 A1
(43) Pub. Date: Aug. 13, 2026

(54) INFORMATION PROCESSING DEVICE, INFORMATION PROCESSING METHOD, AND RECORDINGMEDIUM

(71) Applicant: NEC Corporation, Tokyo (JP)

(72) Inventors: Rui KONDO, Tokyo (JP); Yoshitomo Warashina, Tokyo (JP)

(73) Assignee: NEC Corporation, Tokyo (JP)

(21) Appl. No.: 19/445,868

(22) Filed: Jan. 12, 2026

(30) Foreign Application Priority Data
Feb. 10, 2025 (JP) 2025-019741

(51) Int. Cl. G06Q 30/0242

(52) U.S. Cl. CPC G06Q 30/0242

(57) ABSTRACT

An information processing device includes at least one memory storing instructions, and at least one processor configured to execute the instructions to, acquire advertisement information regarding an advertisement, the advertisement information including at least one of area information of a display device that displays the advertisement and attribute information of a person who visually recognizes the display device, evaluate relevance to the advertisement, based on any one of the area information and the attribute information of the person, and output an evaluation result.

This application is based upon and claims the benefit of priority from Japanese Patent Application No. 2025-019741, filed on Feb. 10, 2025, the disclosure of which is incorporated herein in its entirety by reference.

### TECHNICAL FIELD

The present disclosure relates to an information processing device, an information processing system, an information processing method, and a recording medium.

### BACKGROUND ART

There is a mechanism for changing a charging method for an advertisement displayed on a display device such as a digital signage. For example, JP 2016-134164 A discloses a technique for logging for charging with a difference according to status information collected from at least one sensor of a digital signage device.

In general, an advertiser that displays an advertisement on a digital signage desires to preferentially display an advertisement at a place where people interested in an advertisement content gather in order to enhance an effect of advertisement distribution.

### SUMMARY

An object of the present disclosure has been made in view of the above problems, and an object thereof is to provide an information processing device and the like capable of effectively displaying advertisements.

An information processing device according to an aspect of the present disclosure includes an acquisition means for acquiring advertisement information regarding an advertisement, the advertisement information including at least one of area information of a display device that displays the advertisement and attribute information of a person who visually recognizes the display device, an evaluation means for evaluating relevance to the advertisement, based on any one of the area information and the attribute information of the person, and an output means for outputting an evaluation result.

An information processing system according to one aspect of the present disclosure includes a plurality of display devices that are installed in different regions and display advertisements, a plurality of imaging devices that are respectively provided in the plurality of display devices and each capture an image of a vicinity of the display device, an information processing device that analyzes the plurality of captured images captured by the plurality of imaging devices, and a terminal device that is used by an advertiser, in which the information processing device includes an acquisition means for acquiring advertisement information regarding an advertisement, the advertisement information including at least one of area information of the display device that displays the advertisement and attribute information of a person who visually recognizes the display device, the attribute information being obtained by analyzing the captured image, an evaluation means for evaluating relevance to the advertisement, based on any one of the area information and the attribute information of the person, and an output means for outputting an evaluation result.

An information processing method according to one aspect of the present disclosure includes, by a computer, acquiring advertisement information regarding an advertisement, the advertisement information including at least one of area information of a display device that displays the advertisement and attribute information of a person who visually recognizes the display device, evaluating relevance to the advertisement, based on any one of the area information and the attribute information of the person, and outputting an evaluation result.

A program according to one aspect of the present disclosure causes a computer to execute a process of acquiring advertisement information regarding an advertisement, the advertisement information including at least one of area information of a display device that displays the advertisement and attribute information of a person who visually recognizes the display device, a process of evaluating relevance to the advertisement, based on any one of the area information and the attribute information of the person, and a process of outputting an evaluation result.

Advantageous Effects of Invention

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating an example of an information processing system including an information processing device;

FIG. 2 is a block diagram illustrating an example of a configuration of the information processing device;

FIG. 3 is a flowchart showing an example of an operation of the information processing device according to the present disclosure; and

FIG. 4 is a block diagram illustrating an example of a hardware

configuration of a computer device that implements the information processing device of the present disclosure.

### EXAMPLE EMBODIMENT

### First Example Embodiment

An outline of an information processing device according to a first example embodiment will be described.

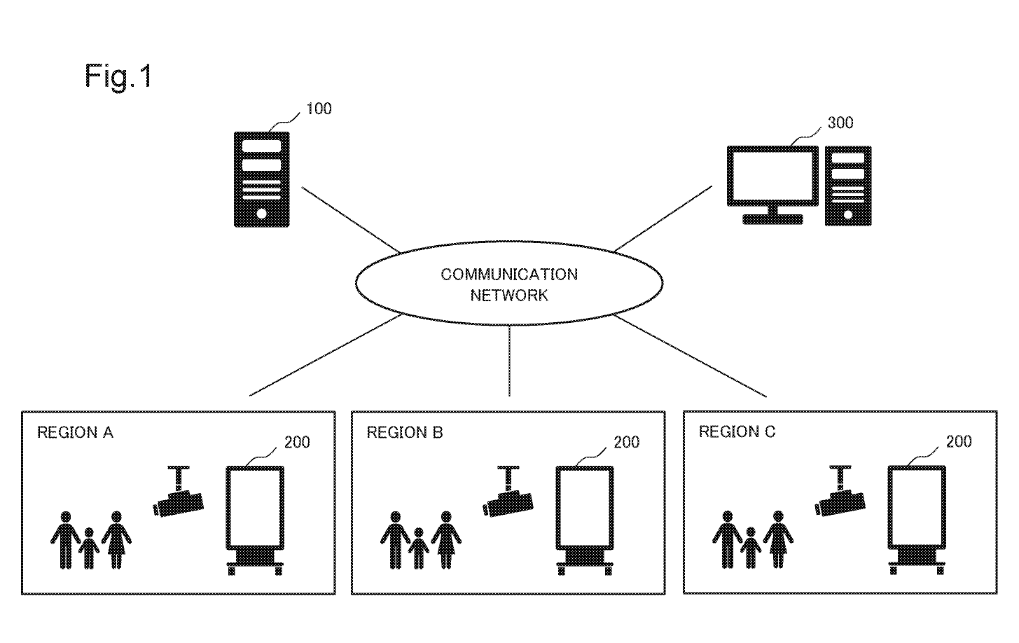

Example embodiments of the present disclosure will be described in detail with reference to the drawings. FIG. 1 is a diagram illustrating an example of a configuration of an information processing system. The information processing system includes, for example, an information processing device 100, a display device 200, and a terminal device 300. The information processing device 100 is connected to the display device 200 and the terminal device 300 via, for example, a communication network. The terminal device 300 is a terminal for an advertiser to input information to the information processing device 100 or to display information output from the information processing device 100.

The information processing device 100 is connected to one or a plurality of display devices 200, and when the information processing device 100 is connected to the plurality of display devices 200, the information processing device 100 includes, for example, signage displays installed at different places. In the example of FIG. 1, signage displays are installed in different regions, but signage displays may be installed at different places in the same region. The region refers to, for example, a group of areas recognized to have common characteristics from the viewpoint of advertisement distribution.

In the present disclosure, a mechanism is used in which, when an advertising effect can be expected, an advertiser can obtain an advertisement spot on the display device 200 even by bidding a lower amount of money. In the present disclosure, in order to search for a display device 200 having a high advertising effect (that is, making it possible to bid a lower amount of money), an advertiser may input information of the display device 200 on which an advertisement is desired to be displayed from the terminal device 300 and evaluate a degree of relevance between the display device 200 and the advertisement. The degree of relevance between each of the plurality of display devices 200 installed at different places and the advertisement may be evaluated. When the degree of relevance between each of the plurality of display devices 200 and the advertisement is evaluated, the advertiser can grasp which display device 200 the advertisement of the advertiser is displayed on to achieve a high advertising effect.

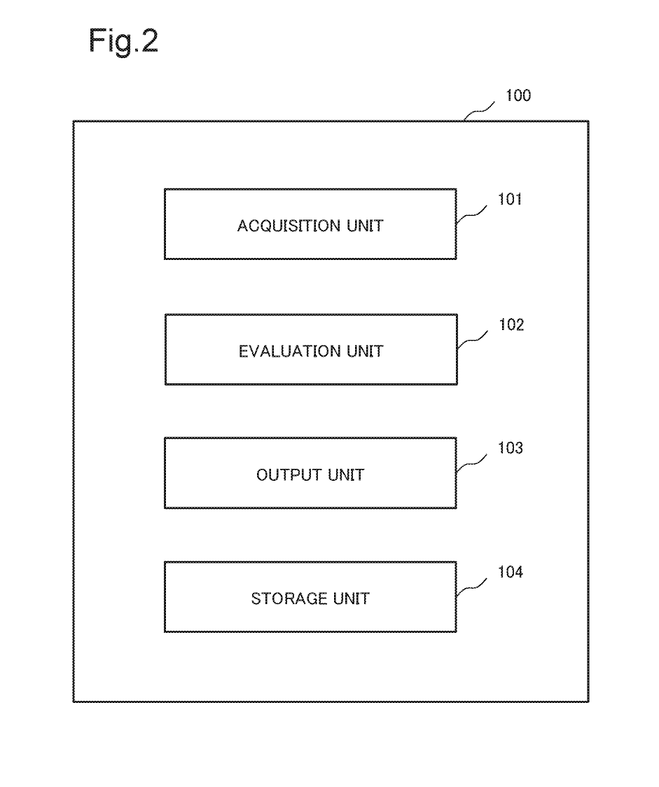

FIG. 2 is a first block diagram illustrating an example of a functional configuration of the information processing device. As illustrated in FIG. 2, the information processing device 100 includes an acquisition unit 101, an evaluation unit 102, an output unit 103, and a storage unit 104.

The storage unit 104 has any configuration, and stores area information of a place where the display device 200 is installed. The storage unit 104 may store attribute information of a person who has visually recognized the display device 200. In FIG. 1, a camera is installed near the display device 200. The storage unit 104 stores attribute information such as the number of persons who have visually recognized the display device 200, a gender ratio and an age ratio of specified persons, and the like obtained by applying known image processing from a captured image captured by the camera. The storage unit 104 may be configured with a server device different from the information processing device 100.

The acquisition unit 101 acquires information regarding an advertisement including either area information in which the display device 200 is installed or attribute information of a person who visually recognizes the display device 200. For example, the acquisition unit 101 acquires, from the storage unit 104 or the like, area information of the display device 200 or attribute information of a person who visually recognizes the display device 200, in addition to advertisement data to be evaluated. The advertisement data is not particularly limited as long as the data can evaluate the relevance to the area information and the attribute information, and may be an advertisement itself displayed on the display device 200, or may be a text indicating an outline of the advertisement, a product service name to be advertised, or an advertiser.

The area information includes region information, and includes a special product represented by each region, a famous product, a tourist spot, a historical building, a main industry, a sports club, a festival, or the like. The area information may include information on the type of installation place such as a station yard, a commercial facility, or a tourist area, and characteristics of an area such as a business area, a tourist area, or a residential area.

The attribute information of the person who visually recognizes the display device 200 includes, for example, a gender, an age, an age group, a person composition, and whether the person is a traveler, a student, or a commuter, and is not particularly limited. Whether the person is a traveler, a student, a commuter, or the like may be specified by belongings or clothes. The person composition may be one person or a group of persons. The person composition is a couple, a husband and wife, parents with child, or the like. The person composition may be estimated from a gender and an age of a person included in the group. An existing technique may be used as an attribute analysis method, and thus a detailed description thereof will be omitted. The attribute information may be information acquired by analyzing an image obtained by imaging a person who visually recognized the display device 200 in the past. The attribute information may be information acquired by analyzing an image obtained by imaging a person who has visually recognized the display device 200 at the timing of evaluation.

The evaluation unit 102 is a means for evaluating relevance to an advertisement, based on either area information or attribute information of a person. The evaluation unit 102 evaluates the relevance to the advertisement, based on whether an industry image or a product category of the advertisement matches an installation place of the display device 200 that displays the advertisement or attribute information of a person who visually recognizes the advertisement.

For example, the evaluation unit 102 calculates a relevance score between the area information or the attribute information of the person and an advertisement content. Various scores can be used as the relevance score, and for example, the relevance may be scored in a range of 0 to 100, or ranks such as A to E may be given.

The evaluation unit 102 may evaluate the relevance by calculating a bid price paid by an advertiser, based on a score, a rank, an expected effect by the advertisement, a competitive situation, or the like. In this case, the evaluation unit 102 evaluates the bid price for displaying the advertisement on the display device 200 to be lower as the relevance between the advertisement and either the area information or the attribute information of the person is higher. This is based on the idea that an advertisement with higher relevance is predicted to be more effective, and thus there is a high possibility that an advertisement spot can be acquired even at a lower price.

For example, it is assumed that area information includes region information regarding a region in which the display device 200 is installed. For example, the evaluation unit 102 may evaluate a bid price to be lower than a predetermined price when displaying an advertisement related to contents specific to the region on the display device 200 installed in the region. The “predetermined price” as used herein refers to a standard price that is set in advance for a specific advertisement spot. Since the bid price is calculated by a known method, details thereof are omitted. For example, it is assumed that a certain display device 200 is installed in a region where an electrical product or an animation-related product is famous. In this case, the evaluation unit 102 determines that the advertisement of the electrical product or the animation-related product has high relevance to the characteristics of the region, and evaluates the advertisement at a lower price than a standard bid price. It is assumed that many of people passing in front of the display device 200 are women in their twenties. In this case, the evaluation unit 102 determines that a fashion advertisement for young women has high relevance, and evaluates the fashion advertisement at a lower price than a standard bid price.

A specific example of a relevance evaluation method in the evaluation unit 102 will be described, but the evaluation method is not limited thereto. The evaluation unit 102 may evaluate compatibility between an advertisement and characteristics of the region where the display device 200 is installed. For example, when an advertisement content is related to a local special product, a tourist spot, a main industry, or the like, the evaluation unit 102 gives a score higher than a standard score. As another example, the evaluation unit 102 gives a score higher than a standard score to each of a high-grade brand advertisement in a region having many high-grade brand stores, a business-related advertisement in a business area, and a tourist information advertisement in a tourist area. On the other hand, the evaluation unit 102 may give a low score to an advertisement having low relevance to the installation place of the display device 200. A more specific example is an advertisement of a game place or the like on the display device 200 in a region having many high-grade brand stores.

The evaluation unit 102 may further evaluate relevance to an advertisement by compatibility with the installation place of the display device 200. Specifically, the evaluation unit 102 gives a score higher than a standard score to a traffic-related advertisement in a station yard, or an advertisement of a product sold in a commercial facility in the case of a commercial facility or its surroundings.

The evaluation unit 102 may evaluate relevance between an advertisement and attribute information of a person who visually recognizes the display device 200. The evaluation unit 102 gives a score higher than a standard score in consideration of conformity with an age group or a gender when matching a target group of an advertisement. The evaluation unit 102 also evaluates relevance to clothes, and gives a high score to each of an advertisement of a business product in a region having many people wearing business clothes and an advertisement of a casual product in a region having many people wearing casual clothes. In consideration of companion information, the evaluation unit 102 gives high scores to an advertisement of a product for a family in a region having many family groups and to an advertisement of a date-oriented service in a region having many couples.

The output unit 103 outputs an evaluation result. For example, information may be displayed on a display of the terminal device 300 by outputting the information to the terminal device 300 by the output unit 103. The output unit 103 displays information such as a relevance score, a rank, an expected advertising effect, and a competitive situation calculated by the evaluation unit 102. When the output unit 103 evaluates relevance between an advertisement and the plurality of display devices 200, the output unit 103 may display information of the display device 200 that has acquired a relevance score of a certain level or more. The output unit 103 may display a bid price for displaying an advertisement on the display device 200 to be evaluated.

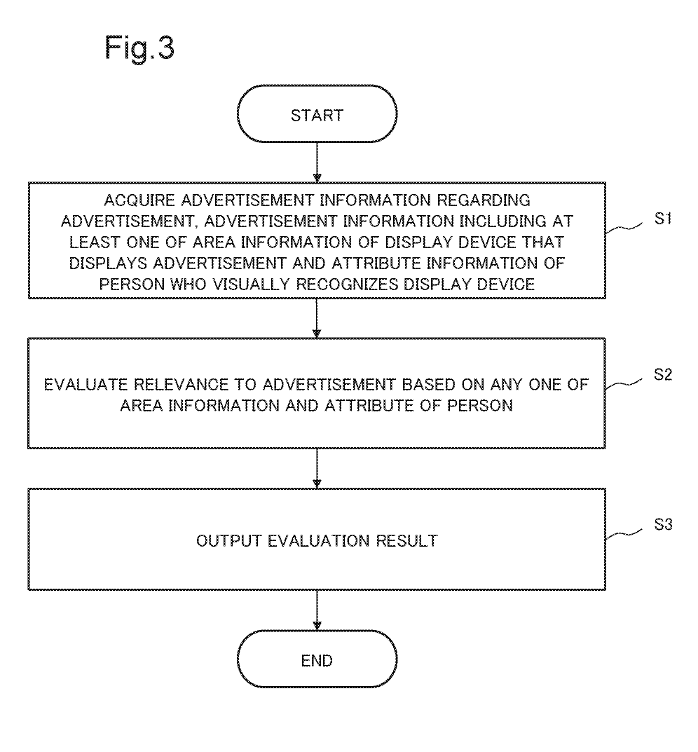

Next, an example of an operation of the information processing device 100 will be described with reference to FIG. 3. FIG. 3 is a flowchart showing an example of an operation of the information processing device 100. In the present disclosure, each step in the flowchart is represented using a number given to the step, such as “S1”. This flowchart is started, for example, by using an operation for evaluating an advertisement by an advertiser as a trigger.

The acquisition unit 101 acquires advertisement information regarding an advertisement including at least one of area information of the display device 200 that displays the advertisement and attribute information of a person who visually recognizes the display device 200 (S1).

The evaluation unit 102 evaluates relevance to the advertisement, based on either the area information or the attribute information of the person (S2).

The output unit 103 outputs an evaluation result (S3).

In this manner, in the information processing device 100, the evaluation unit 102 evaluates the relevance to the advertisement, based on at least one of the area information of the display device that displays the advertisement and the attribute information of the person who visually recognizes the display device 200. The output unit 103 outputs an evaluation result. An advertiser can achieve effective advertisement distribution by deciding a bid for an advertisement based on the evaluation result.

The information processing device 100 may include a control unit (not illustrated) for automatically distributing an advertisement. The control unit collates bid conditions of the advertisement acquired in advance from the advertiser with the evaluation result obtained by the evaluation unit 102, and performs control in such a way as to automatically display the advertisement on the display device 200 when the condition is matched. More specifically, the control unit receives in advance information of an upper limit amount that can be paid for the display of the advertisement on the display device 200 from the advertiser, and when a bid price evaluated by the evaluation unit 102 is lower than the upper limit amount that can be paid, the control unit transmits a command for displaying the advertisement to a server controlling the display device 200. Thereby, it is possible to efficiently distribute the advertisement in real time, and it is possible to reduce labor for the advertiser and to efficiently operate an advertisement spot for the operator of the display device 200.

### Modification Example

Next, a modification example will be described. This modification example is basically the same as the first example embodiment except for the operation of the evaluation unit 102, and thus some overlapping descriptions will be omitted.

In the modification example, the evaluation unit 102 evaluates relevance to an advertisement displayed on the display device 200, based on area information and attribute information. When both the area information and the attribute information can be used, the evaluation unit 102 may combine the area information and the attribute information to perform composite evaluation. As a specific example, when two pieces of information in which area information indicates a tourist area and attribute information indicates many people wearing tourist clothes match each other, the evaluation unit 102 gives a particularly high relevance score to the advertisement of the special product of the region. For example, the evaluation unit 102 gives scores as follows. That is, a score when considering only the area information is 70 points, a score when considering only the attribute information is 75 points, and a score when combining the area information and the attribute information is 90 points. In this manner, by combining the area information and the attribute information, a score higher than when each piece of information is individually evaluated is given. This is because, in a place that is a tourist area and has many tourists, it is determined that an advertisement of a special product of a region is more effective.

The evaluation unit 102 may evaluate relevance by weighting the area information and the attribute information differently depending on the situation. For example, the evaluation unit 102 may give a high weight to the attribute information in the case of a product in which an individual’s preference is strongly reflected, and may give a high weight to the area information in the case of information in which regional characteristics are important to evaluate the relevance.

In the modification example, the evaluation unit 102 evaluates relevance to an advertisement displayed on the display device 200, based on area information and attribute information. In this case, it is possible to search for a display device 200 in which the advertisement matches the area information and the attribute information, and to expect a higher advertising effect.

### Configuration Example of Hardware of information Processing Device

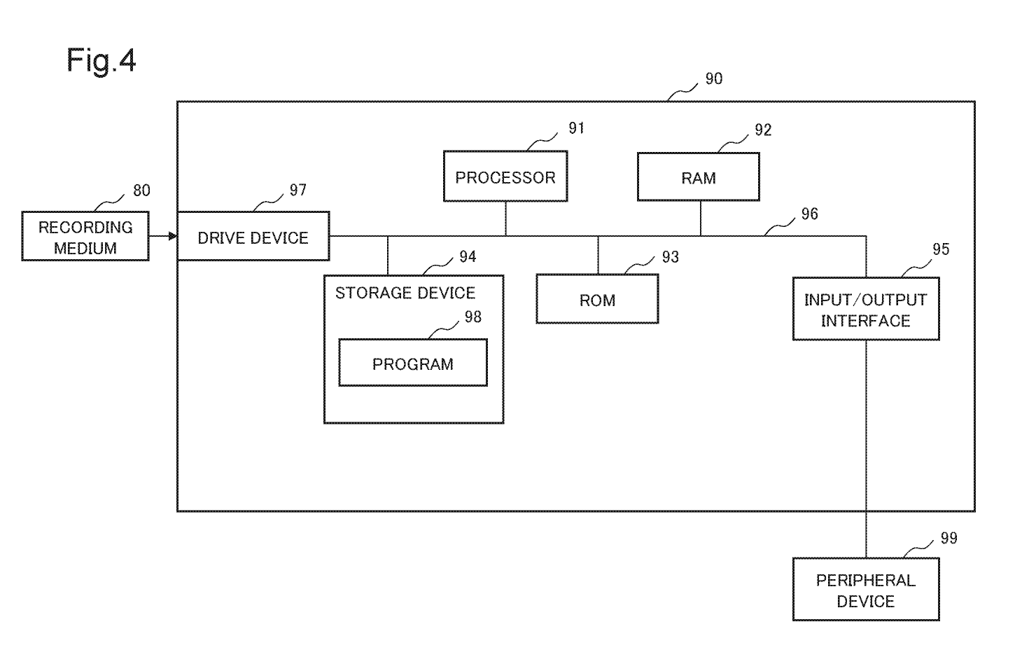

Hardware configuring the information processing devices according to the first example embodiment and the modification example described above will be described. FIG. 4 is a block diagram illustrating an example of a hardware configuration of a computer device configuring the information processing device according to each example embodiment. In a computer device 90, the information processing device and the information processing method described in each example embodiment and each modification example are implemented. For example, the information processing device and the like described in each example embodiment and each modification example may have a hardware configuration illustrated in FIG. 4.

As illustrated in FIG. 4, the computer device 90 includes a processor 91, a random access memory (RAM) 92, a read only memory (ROM) 93, a storage device 94, an input/output interface 95, a bus 96, and a drive device 97. The information processing device and the like may be implemented by a plurality of electric circuits.

The storage device 94 stores a program (computer program) 98. The processor 91 executes the program 98 of the information processing device using the RAM 92. Specifically, for example, the program 98 includes a program that causes a computer to execute the processing illustrated in FIG. 3 and the like, for example. When the processor 91 executes the program 98, the function of each configuration of the information processing device is implemented. The program 98 may be stored in the ROM 93. The program 98 may be recorded in a recording medium 80 and read by the drive device 97, or may be transmitted from an external device (not illustrated) to the computer device 90 via a network (not illustrated).

The input/output interface 95 exchanges data with a peripheral device (such as a keyboard, a mouse, or a display device) 99. The input/output interface 95 functions as a means for acquiring or outputting data. The bus 96 connects the components with each other.

There are various modification examples of the method of implementing the information processing device. For example, each of the components included in the information processing device can be implemented as a dedicated device. The information processing device can be implemented based on a combination of a plurality of devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the present disclosure has been particularly shown and described with reference to example embodiments thereof, the present disclosure is not limited to these example embodiments. It will be understood by those of ordinary skill in the art that various changes in configuration and details may be made therein without departing from the spirit and scope of the present disclosure.

The above-described example embodiments and modification examples can be appropriately combined with each other. All the functions of the example embodiments in the present disclosure can be performed simultaneously within a consistent range.

### Supplementary Note

Some or all of the above example embodiments may be described as the following supplementary notes, but are not limited to the following.

### Supplementary Note 1

An information processing device including:

an acquisition means for acquiring advertisement information regarding an advertisement, the advertisement information including at least one of area information of a display device that displays the advertisement and attribute information of a person who visually recognizes the display device;

an evaluation means for evaluating relevance to the advertisement, based on any one of the area information and the attribute information of the person; and

an output means for outputting an evaluation result.

### Supplementary Note 2

The information processing device according to Supplementary Note 1, in which the evaluation means evaluates a bid price for displaying the advertisement on the display device to be lower as relevance between the advertisement and any one of the area information and the attribute information of the person is higher.

### Supplementary Note 3

The information processing device according to Supplementary Note 2, in which

the area information includes region information regarding a region in which the display device is installed, and

the evaluation means evaluates that the bid price is lower than a predetermined price when an advertisement related to contents specific to the region is displayed on a display device installed in a specific region.

### Supplementary Note 4

The information processing device according to Supplementary Note 1, in which the acquisition means acquires the attribute information of the person from a captured image in which a vicinity of the display device is captured.

### Supplementary Note 5

The information processing device according to Supplementary Note 1, in which

the advertisement information includes both the area information and the attribute information of the person, and

the evaluation means evaluates the relevance to the advertisement, based on the area information and the attribute information.

### Supplementary Note 6

The information processing device according to Supplementary Note 1, in which the output means outputs a bid price necessary for displaying the advertisement on the display device.

### Supplementary Note 7

The information processing device according to any one of Supplementary Notes 1 to 6, in which

the acquisition means acquires advertisement information regarding an advertisement, the advertisement information including at least one of pieces of area information of a plurality of display devices installed in different areas or pieces of attribute information of persons who visually recognize the display devices,

the evaluation means evaluates relevance to the advertisement, based on either the pieces of area information or the pieces of attribute information, and

the output means outputs information of a display device having relevance equal to or higher than a predetermined level.

### Supplementary Note 8

An information processing system including:

a plurality of display devices that are installed in different regions and display advertisements;

a plurality of imaging devices that are respectively provided in the plurality of display devices and each capture an image of a vicinity of the display device;

an information processing device that analyzes the plurality of captured images captured by the plurality of imaging devices; and

a terminal device that is used by an advertiser,

in which the information processing device includes

an acquisition means for acquiring advertisement information regarding an advertisement, the advertisement information including at least one of area information of a display device that displays the advertisement and attribute information of a person who visually recognizes the display device, the attribute information being obtained by analyzing the captured image,

an evaluation means for evaluating relevance to the advertisement, based on any one of the area information and the attribute information of the person, and

an output means for outputting an evaluation result.

### Supplementary Note 9

An information processing method comprising:

by a computer,

acquiring advertisement information regarding an advertisement, the advertisement information including at least one of area information of a display device that displays the advertisement and attribute information of a person who visually recognizes the display device;

evaluating relevance to the advertisement, based on any one of the area information and the attribute information of the person; and

outputting an evaluation result.

### Supplementary Note 10

A program causing a computer to execute

a process of acquiring advertisement information regarding an advertisement, the advertisement information including at least one of area information of a display device that displays the advertisement and attribute information of a person who visually recognizes the display device,

a process of evaluating relevance to the advertisement, based on any one of the area information and the attribute information of the person, and

a process of outputting an evaluation result.

Some or all of the configurations described in Supplementary Notes 2 to 7 dependent on the above-described Supplementary Note 1 can also be dependent on Supplementary Notes 8, 9, and 10 by the same dependency relationship as in Supplementary Notes 2 to 7. Some or all of the configurations described as a Supplementary Note can be similarly dependent on various hardware, software, various recording means for recording software, or systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
at least one memory storing instructions; and
at least one processor configured to execute the instructions to:
acquire advertisement information regarding an advertisement, the advertisement information including at least one of area information of a display device that displays the advertisement and attribute information of a person who visually recognizes the display device;
evaluate relevance to the advertisement, based on any one of the area information and the attribute information of the person; and
output an evaluation result.

2. The information processing device according to claim 1,
wherein the at least one processor is further configured to execute the instructions to:
evaluate a bid price for displaying the advertisement on the display device to be lower as relevance between the advertisement and any one of the area information and the attribute information of the person is higher.

3. The information processing device according to claim 2,
wherein the at least one processor is further configured to execute the instructions to:
evaluate that the bid price is lower than a predetermined price when an advertisement related to contents specific to a region is displayed on a display device installed in a specific region, the area information including region information regarding the region in which the display device is installed.

4. The information processing device according to claim 1,
wherein the at least one processor is further configured to execute the instructions to:
acquire the attribute information of the person from a captured image in which a vicinity of the display device is captured.

5. The information processing device according to claim 1,
wherein the at least one processor is further configured to execute the instructions to:
evaluate the relevance to the advertisement, based on the area information and the attribute information of the person, the advertisement information including both the area information and the attribute information.

6. The information processing device according to claim 1,
wherein the at least one processor is further configured to execute the instructions to:
output a bid price necessary for displaying the advertisement on the display device.

7. The information processing device according to claim 1,
wherein the at least one processor is further configured to execute the instructions to:
acquire advertisement information regarding an advertisement, the advertisement information including at least one of pieces of area information of a plurality of display devices installed in different areas or pieces of attribute information of persons who visually recognize the display devices,
evaluate relevance to the advertisement, based on either the pieces of area information or the pieces of attribute information, and
output information of a display device having relevance equal to or higher than a predetermined level.

8. An information processing method comprising:
by a computer,
acquiring advertisement information regarding an advertisement, the advertisement information including at least one of area information of a display device that displays the advertisement and attribute information of a person who visually recognizes the display device;
evaluating relevance to the advertisement, based on any one of the area information and the attribute information of the person; and
outputting an evaluation result.

9. A non-transitory recording medium recording a program for causing a computer to execute the processing of:
acquiring advertisement information regarding an advertisement, the advertisement information including at least one of area information of a display device that displays the advertisement and attribute information of a person who visually recognizes the display device;
evaluating relevance to the advertisement, based on any one of the area information and the attribute information of the person; and
outputting an evaluation result.
